(19) United States
(12) Patent Application Publication
(10) Pub. No.: US 2012/0128567 A1
(43) Pub. Date: May 24, 2012

(54) PROCESS FOR WORKUP OF LIQUID RESIDUES OF THE DIRECT SYNTHESIS OF ORGANOCHLOROSILANES

(75) Inventors: Gudrun Tamme, Moritzburg/OT Boxdorf (DE); Konrad Mautner, Burghausen (DE); Werner Geissler, Thiendorf/OT Loetzschen (DE)

(73) Assignee: WACKER CHEMIE AG, Muenchen (DE)

(21) Appl. No.: 13/294,691

(22) Filed: Nov. 11, 2011

(30) Foreign Application Priority Data
Nov. 23, 2010 (DE) 10 2010 061 814.4

(51) Int. Cl. C01B 33/107; C01B 33/00; C07F 7/14

(52) U.S. Cl. 423/342; 556/468; 423/324

(57) ABSTRACT

The invention provides a process for thermal cleavage of the high-boiling residues of the direct Müller-Rochow synthesis to give silanes with hydrogen chloride in a fluidized bed of silicon dioxide-containing, aluminum-free particles.

### BACKGROUND OF THE INVENTION

The invention relates to a process for thermal cleavage of the high-boiling residues of the direct Müller-Rochow synthesis to give silanes with hydrogen chloride.

The direct synthesis of organochlorosilanes of the formula RₐH_{b}SiCl_{4-a-b} where a=1 and b=0, 1 or 2 from silicon metal and alkyl chlorides, where R is more preferably methyl, forms, as by-products, oligosilanes, carbosilanes, siloxanes and high-boiling cracking products. Additionally present in the distillation residue are solids from the direct synthesis which, being ultrafines, are not retained even by cyclones and filters. The solids consist of silicon, metal chlorides, metal silicides and soot.

The predominant portion of these distillation residues is made up by the oligosilanes, particularly the disilanes R_{c}Cl_{6-c}Si₂ where c=0-6. Processes were therefore developed at an early stage to convert disilanes to monosilanes. This is possible, for example, by amine-catalyzed cleavage with hydrogen chloride, described by way of example in U.S. Pat. No. 2,709,176. However, this process can cleave only disilanes with fewer than 4 methyl groups. Furthermore, the disilanes have to be removed from the solid residues beforehand, since these residues, for example aluminum chloride, act as catalyst poisons.

In order also to utilize what are called the noncleavable disilanes, processes have been developed in which noncleavable disilanes are converted to cleavable disilanes and then cleaved, for example U.S. Pat. No. 4,393,229, in which these disilanes are cleaved directly with HCl over specific catalysts usually containing noble metals, for example DE 44 31 995, or in which disilanes are cleaved with hydrogen over metal catalysts, for example U.S. Pat. No. 4,079,071. The advantage of the hydrogenation is that carbosilanes of the R′₃Si—CH₂—SiR′₃ type where R′=H, C₁-C₄-alkyl or halogen can also be cleaved to hydrogen-containing monosilanes. A disadvantage of metal-catalyzed conversions is always the tendency of the catalysts to be poisoned by impurities from the residue. Hydrogenations additionally require relatively high pressures. This distinctly increases the apparatus complexity.

A combination of the latter processes in one step is described in U.S. Pat. No. 5,430,168, wherein addition of metal catalysts can be dispensed with, but not relatively high pressures.

DE 936 444 describes a process in which relatively high-boiling residues of the direct synthesis of methylchlorosilanes are converted without catalysis and purely thermally in an autoclave or in an empty pipe with hydrogen chloride at temperatures of 400-900° C. to monomeric silanes. The great advantage emphasized therein associated with the use of a tubular reactor is the low coking tendency, as a result of which the process can run over a longer period.

However, it is necessary to pretreat the residues which, by virtue of their solids content, can otherwise lead rapidly to the blockage of reaction tubes. DE 10354262 describes cleavage with minimization of solid residues at the reactor wall, by introducing the reaction temperature needed via the hydrogen chloride stream and not via the apparatus jacket.

DE 19711693 additionally describes rotatable internals in the reaction tube, which scrape off caked material.

The cleavage of solids-containing high-boiling methylchlorosilane residues with hydrogen chloride according to DE 10039172 in a silicon fluidized bed gives good cleavage results, but the product mixture comprising trichlorosilane, silicon tetrachloride and the methylchlorosilane mixture obtainable in this process requires a more complex separation process since, on the industrial scale, it fits neither a trichlorosilane plant nor a methylchlorosilane plant. EP 635510 describes the conversion of a solids-containing high boiler mixture in a moving bed over platinum-containing alumina support, aluminum chloride support or zeolite, an aluminosilicate. However, noble metal catalysts are quite expensive. Aluminum chloride supports and zeolites release aluminum chloride under the process conditions, which can be removed from the silane mixture prepared only with difficulty.

### DESCRIPTION OF THE INVENTION

The invention provides a process for thermal cleavage of the high-boiling residues of the direct Müller-Rochow synthesis to give silanes with hydrogen chloride in a fluidized bed of silicon dioxide-containing, aluminum-free particles.

The process is very simple to perform. It is possible to work up all liquid residues, even those containing solids, of the direct Müller-Rochow synthesis of organochlorosilanes at low pressures, and to convert the organosilicon components to utilizable monosilanes. Solid deposits on the reactor walls are very substantially avoided.

The residues of the direct synthesis preferably have a boiling point above 70° C., especially of at least 100° C., at 1013 hPa.

In the process, preferably high molecular weight constituents of the residues are cleaved to monosilanes. Preferably the oligosilanes and especially the disilanes of the general formula R_{c}Cl_{6-c}Si₂ where c=0-6, R=alkyl are cleaved. The residues of the direct synthesis may comprise metals or compounds thereof in dissolved or finely suspended form. More particularly, the residues comprise metals from the group of Al, Cu, Zn, Sn, Fe, Ti and/or compounds thereof. The residues may also comprise further solids, such as silicon and soot.

Preferably, no catalysts and no further feedstocks are used in the process.

Preferably, methylchlorosilanes of the general formula MeₐH_{b}SiCl_{4-a-b} are prepared, in which Me is a methyl radical, a has the values of 1, 2 or 3 and b has the values of 0 or 1.

The silicon dioxide-containing, aluminum-free particles used may be silicon dioxide-containing ceramic or mineral materials, such as quartz, ceramic or acid-washed and calcined sand. The silicon dioxide content is preferably at least 90% by weight, especially at least 99% by weight. The silicon dioxide-containing, aluminum-free particles contain preferably at most 0.1% by weight, especially at most 0.01% by weight, of aluminum. Particular preference is given to quartz.

The particles are used in a particle size distribution favorable for the reactor type used. The particle size of the particles is preferably at least 50 μm, especially at least 80 μm, and preferably at most 1000 μm, especially at most 500 μm.

The residues of the direct synthesis having a boiling point above 70° C. are fed together with hydrogen chloride into a fluidized bed reactor. The mixing can be effected upstream of or not until within the reactor when a conical inflow plate is used. If the fluidized bed lies on a gas distributor plate, the inflow of hydrogen chloride is from below, while the liquid residue to be converted is introduced above the plate in a suitable manner, optionally atomized with a portion of hydrogen chloride.

The amount of hydrogen chloride used is at least the molar equivalent corresponding to the oligosilanes, especially disilanes, present in the residue, but preferably not more than the amount needed to maintain a fluidized bed. Preference is given to using 1.1-10 times the molar amount. The residue and the hydrogen chloride can be metered into the reactor either in preheated form, preferably by utilization of waste heat, or at ambient temperature, the streams preferably being metered in continuously.

The fluidized bed reactor consists of a jacket which is heatable directly or indirectly up to 650° C. In addition, the reactor may be equipped with one or more temperature control fingers. Possible heating methods are high-temperature-resistant heat carrier oils, electric resistance heating, induction heating or combinations thereof.

The reactor is operated preferably at at least 400° C., especially at least 500° C., and preferably at most 650° C., especially at most 600° C.

The pressure is preferably at least 50 hPa, especially at least 1000 hPa, and preferably at most 10000 hPa, especially at most 3000 hPa.

The fluidized bed prevents any caking and comminutes caked material. Deposits on the particle are pulverized and discharged with the gas stream. A positive side effect of the heat treatment is sintering of the solid particles, which allows solids which are difficult to filter and may be in colloidal distribution to be converted to filterable components or to be discharged in powder form by means of cyclones, and to be processed by known processes for treatment of dust residues from the direct synthesis.

The output mixture is preferably condensed and optionally freed of solids, and can be fed back to the silane mixture obtained in the direct synthesis, or else separated separately into pure substances. Excess hydrogen chloride can be recovered by known methods and fed back to the reaction.

In the examples which follow, unless stated otherwise in each case, all amounts and percentages are based on weight, all pressures are 1000 hPa (abs.) and all temperatures are 20° C.

### Example 1 (Analogous to DE 936 444; Noninventive)

180 ml/h of high-boiling residue of the silane synthesis with a boiling point of >150° C. were metered together with 25 l/h of gaseous hydrogen chloride in cocurrent at room temperature and ambient pressure into an empty, horizontal steel tube of length 700 mm and internal diameter 25 mm, which was within a tubular furnace. The tubular furnace was set to a temperature of 550° C. The high-boiling residue consisted of 80% disilanes (mixture of 1,1,2,2-tetrachlorodimethyldisilane, 1,1,2-trichlorotrimethyldisilane and 1,2-dichlorotetramethyldisilane, 2% solids and 18% siloxanes and carbosilanes). A more exact assignment was difficult due to the multitude of by-products. After 17 hours of operation, the test was stopped since the tubular reactor had become blocked in the reaction zone by solids and cracking products.

The result of the test was a cleaved silane with the composition specified in table 1:

| | Proportion in the cleaved |
|---|---|
| Substance | silane [% by wt.] |
| dimethylchlorosilane | 1.00 |
| methyldichlorosilane | 10.00 |
| trimethylchlorosilane | 2.00 |
| methyltrichlorosilane | 35.00 |
| dimethyldichlorosilane | 32.00 |
| solids | 3.00 |
| others | 17.00 |

### Examples 2 to 4 (Inventive)

25 l/h of gaseous hydrogen chloride were introduced at room temperature and ambient pressure into a glass laboratory fluidized bed reactor (length 500 mm, diameter 40 mm) with an installed frit as a gas distributor and filled with 270 g of quartz powder of particle fraction 100-315 μm to obtain a fluidized bed. The reactor was heated to 550° C. by means of electrical heating. The high-boiler mixture to be converted was atomized at 60 g/h above the frit by means of a pump. Even after 50 hours of operation, no deposits were found in the reactor or on the nondiscolored quartz. The tests resulted in the following cleaved silanes from different high boiler mixtures with the compositions of the product mixtures specified in table 2:

TABLE 2

| | Example 2 | | Example 3 | | Example 4 | |
|---|---|---|---|---|---|---|
| | High | Product | High | Product | High | Product |
| | boiler | mixture | boiler | mixture | boiler | mixture |
| | mixture | A | mixture | B | mixture | C |
| | A (% | (% by | B (% | (% by | C (% | (% by |
| | by wt.) | wt.) | by wt.) | wt.) | by wt.) | wt.) |
| HM2 | | 0.9 | | | | 1.8 |
| Sitri | | 1.1 | | 4.4 | | |
| HM | 0.1 | 19.8 | 0.1 | 20.9 | | 1.4 |
| M3 | 0.1 | 1.4 | 0.1 | 4.1 | | 5.3 |
| SiCl₄ | | 0.7 | | | | 0.1 |
| M1 | | 39.4 | | 27 | | 6.5 |
| M2 | 1.9 | 23.9 | 9.6 | 27 | 3.0 | 20.8 |
| EMDCS/ETS | 0.1 | 0.4 | 1.6 | 1.6 | 6.5 | 7.2 |
| M6-Di | 0.1 | | 1.4 | 0.1 | 3.3 | 0.5 |
| M5-Di | 0.3 | 0.2 | 4.6 | 1.0 | 15.8 | 3.9 |
| M4-Di-uns | 1.1 | 0.8 | 1.2 | 0.5 | 1.1 | 1.2 |
| M4-Di-sym | 0.82 | 0.86 | 6.5 | 0.8 | 23.6 | 2.5 |
| M3-Di | 28.6 | 0.1 | 20.4 | 0.7 | 8.1 | 2.9 |
| M2-Di | 47.9 | 0.9 | 42.4 | 0.7 | 4.3 | 0.7 |

The abbreviations mean:
HM2 dimethylchlorosilane
Sitri trichlorosilane
HM methyldichlorosilane
M3 trimethylchlorosilane
M1 methyltrichlorosilane
M2 dimethyldichlorosilane
EMDCS/ETS ethylmethyldichlorosilane/ethyltrichlorosilane
M6-Di hexamethyldisilane
M5-Di chloropentamethyldisilane
M4-Di-uns dichlorotetramethyldisilane unsymmetric
M4-Di-sym dichlorotetramethyldisilane symmetric
M3-Di trichlorotrimethyldisilane
M2-Di tetrachlorodimethyldisilane

Substances making up the 100% are unspecified intermediate and higher boilers. In the offgas of the reaction are not only unconverted hydrogen chloride and incompletely converted silanes, but also up to 3% by weight of hydrogen and hydrocarbons such as methane, ethane, ethene, butane, butene.

1. A process for thermal cleavage of high-boiling residues of a direct Müller-Rochow synthesis to give silanes with hydrogen chloride in a fluidized bed of silicon dioxide-containing, aluminum-free particles.

2. The process as claimed in claim 1, in which disilanes of the general formula R_{c}Cl_{6-c}Si₂ where c=0-6, R=alkyl are cleaved.

3. The process as claimed in claim 1, in which the silicon dioxide-containing, aluminum-free particles are selected from the group consisting of quartz, ceramic and acid-washed and calcined sand.

4. The process as claimed in claim 1, in which a particle size of the particles is 50 μm to 1000 μm.

5. The process as claimed in claim 1, which is performed at temperatures of 400 to 650° C.

6. The process as claimed in claim 2, in which the silicon dioxide-containing, aluminum-free particles are selected from the group consisting of quartz, ceramic and acid-washed and calcined sand.

7. The process as claimed in claim 6, in which a particle size of the particles is 50 μm to 1000 μm.

8. The process as claimed in claim 7, which is performed at temperatures of 400 to 650° C.
